(19) United States
(12) Patent Application Publication
(10) Pub. No.: US 2025/0328813 A1
(43) Pub. Date: Oct. 23, 2025

(54) Placing Content In Compatible Metaverse Environments

(71) Applicant: Oracle International Corporation, Redwood Shores, CA (US)

(72) Inventors: Jason Canney, Highlands Ranch, CO (US); Frank Appiah, Greenwood Village, CO (US); Christopher Stark, Verona, NJ (US); John Orosa, Cambridge (GB)

(73) Assignee: Oracle International Corporation, Redwood Shores, CA (US)

(21) Appl. No.: 18/640,373

(22) Filed: Apr. 19, 2024

(51) Int. Cl. G06N 20/00

(52) U.S. Cl. CPC G06N 20/00

(57) ABSTRACT

Techniques for placing content in metaverses in environments contextually compatible with the content are disclosed. A system trains a machine learning model to identify virtual environments compatible with content based on attributes representing contexts of the environments. Using the machine learning model, the system determines an environment for a target content item. The system selects the particular environment for placement of the target content item based on the compatibility score.

### BENEFIT CLAIMS; RELATED APPLICATIONS; INCORPORATION BY REFERENCE

The following application is hereby incorporated by reference: U.S. application Ser. No. 18/310,930, filed May 2, 2023.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure generally relates to presenting content in metaverses and, more particularly, to selecting metaverse environments to present content based on attributes of the environments.

### BACKGROUND

Metaverses allow people to socialize and interact in computer-generated environments. Examples of metaverses include virtual reality games, immersive social platforms, training simulations, and virtual worlds. A metaverse may, for example, represent a city using three-dimensional (3D) graphics that simulate interactive landscapes, flora, fauna, characters, buildings, furniture, tools, vehicles, and other objects. Using a computer interface, a user may control an avatar to traverse the metaverse and interact with other users, objects, and content.

Metaverses may be inhabited by virtual retailers offering goods and services inside and outside the metaverse. For example, a metaverse can include a virtual automotive dealership that generates revenue selling virtual vehicles operable by avatars. The virtual dealership can also be associated with a real-world manufacturer producing actual vehicles. The virtual dealership can generate additional revenue by presenting advertisements for the manufacturer, selling virtual vehicles representing the real-world vehicles, referring customers to real-world dealerships, and even selling real-world vehicles via the metaverse.

As metaverses become more common, retailers are increasingly placing promotional content in virtual locations. The immersive nature of metaverses generates granular information about user preferences, behaviors, and interactions occurring in a metaverse. By gathering and analyzing the information, retailers can more effectively target the promotional content in metaverses.

The approaches described in this section are approaches that could be pursued, but not necessarily approaches that have been previously conceived or pursued. Therefore, unless otherwise indicated, one should not assume that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. One should note that references to “an” or “one” embodiment in this disclosure are not necessarily to the same embodiment, and they mean at least one. In the drawings:

FIG. 1A illustrates an example environment selection architecture in accordance with one or more embodiments;

FIG. 1B illustrates an environment selection system in accordance with one or more embodiments;

FIGS. 2A and 2B illustrate an example set of operations for selecting metaverse environments to place content in accordance with one or more embodiments;

FIG. 3 illustrates an example of selecting metaverse environments to place content in accordance with one or more embodiments; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. METAVERSE ENVIRONMENT SELECTION ARCHITECTURE
3. METAVERSE ENVIRONMENT SELECTION SYSTEM
4. SELECTING METAVERSE ENVIRONMENTS FOR CONTENT
5. EXAMPLE EMBODIMENT OF SELECTING METAVERSE ENVIRONMENTS FOR CONTENT
6. HARDWARE OVERVIEW
7. MISCELLANEOUS; EXTENSIONS

### 1. GENERAL OVERVIEW

A metaverse may include numerous environments having different contexts. The contexts can be differentiated by, for example, type, themes, settings, goals, demographics, characteristics, etc. The subject matter of an item of content may be more compatible with one environment than another. For example, an advertisement for beer may be incompatible with a children's farming simulation and compatible with a sporting event simulation.

One or more embodiments select a metaverse environment for presentation of content based on a compatibility score for the metaverse environment and the content. A system determines a compatibility score between a particular content item and multiple environments. A compatibility score quantifies the extent of alignment and relevance between the context of a target content item and the contexts of the metaverse environments where the content item may be placed. Based on the compatibility scores, the system selects an environment that is compatible with the content.

One or more embodiments train a machine learning model to determine a compatibility score representing compatibility between a content item and metaverse environments. The system identifies a particular content item for placement in the metaverse along with candidate environments of the metaverse for presenting the content item. The system applies the machine learning model to attributes of the first content item and attributes of the candidate metaverse environments to compute scores representing respective levels of compatibility between the content item and the candidate metaverse environments. Based the compatibility scores, the system selects one of the candidate environments for placement of the content item.

One or more embodiments described in this Specification and/or recited in the claims may not be included in this General Overview section.

### 2. ENVIRONMENT SELECTION ARCHITECTURE

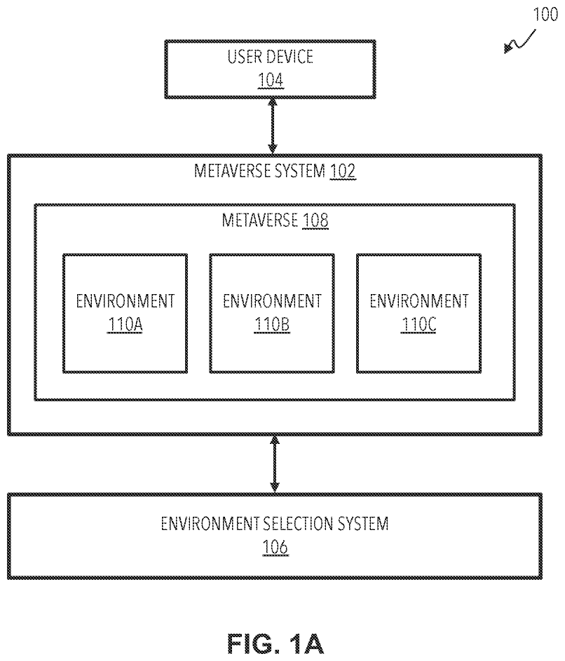

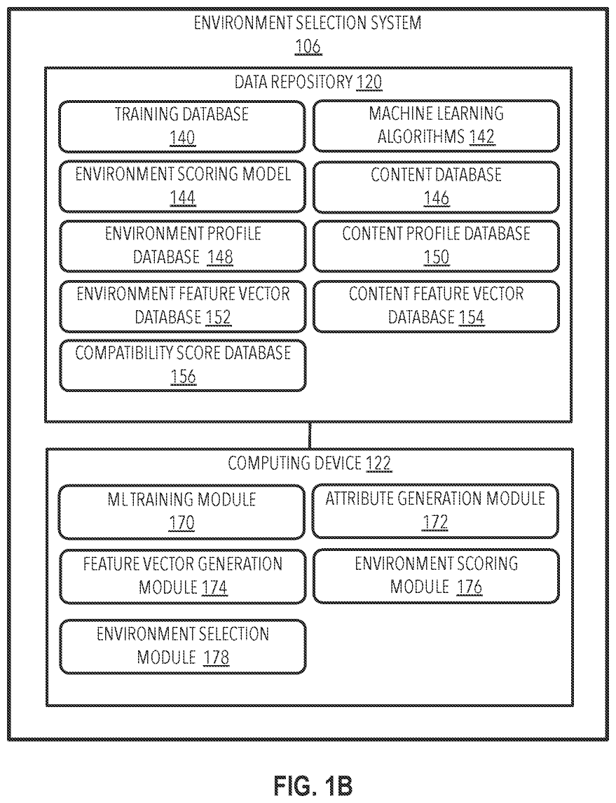

FIG. 1A illustrates an example environment selection architecture 100 in accordance with aspects of the present disclosure. The example environment selection architecture 100 includes a metaverse system 102, a user device 104, and an environment selection system 106. In one or more embodiments, the example environment selection architecture 100 may include more or fewer components than the components illustrated in FIG. 1A. The components illustrated in FIG. 1A may be local to or remote from each other. The components illustrated in FIG. 1A may be implemented in software and/or hardware. Components may be distributed over multiple applications and/or machines. Multiple components may be combined into one application and/or machine. Operations described with respect to one component may instead be performed by another component.

The metaverse system 102 is one or more computing devices that generate, update, manage, and control a metaverse 108. The metaverse 108 is a computer-generated representation of a three-dimensional, interactive, virtual world that simulates real-world or fictional environments. The metaverse 108 incorporates elements of physical and social models of natural phenomena, interactions, and behaviors among users, characters, objects, and other elements of the metaverse 108. For example, the metaverse 108 can be one or more of a virtual reality game, immersive social platform, training simulation, virtual research, development, test and evaluation platform, and the like.

The metaverse 108 includes environments 110A, 110B, and 110C. An environment 110 is a portion or subset of the metaverse 108 having a context different than other environments 110 within the metaverse 108. As used herein, “context” refers to types, themes, settings, user roles, user demographics, and/or other characteristics of a particular environment 110. For example, environment 110A may represent an educational environment, environment 110B may represent an arcade game environment, and environment 110C may represent a sporting environment.

The user device 104 is one or more computing devices communicatively linked with the metaverse system 102 that interact with the metaverse 108 and the environments 110 in the metaverse. The user device 104 may be a personal computer, workstation, server, mobile device, mobile phone, tablet device, and/or other processing device capable of implementing and/or executing software, applications, etc. The user device 104 generates a computer-user interface that enables a user to access, perceive, and interact with the metaverse 108 using input/output devices, such as a video displays, head-mounted displays, audio transducers, pointer devices, keyboards, and/or a tactile feedback devices. Via the user device 104, the user controls an avatar to navigate, interact, and engage with the metaverse 108, other users, and virtual objects. An “avatar” refers to a digital entity or character serving as the visual and interactive representation of a user within the metaverse. The user controls movement and actions of the avatar within the metaverse 108 using input devices, such as keyboards, mice, game controllers, or motion-sensing devices. The avatars can walk, run, fly, teleport, gesture, emote, and interact with virtual objects and other avatars.

The environment selection system 106 is one or more computing devices communicatively linked with the metaverse system 102 that determines environments 110 for placement of content in the metaverse 108 based on the respective contexts of the content and the environments 110. As detailed below, the environment selection system 106 generates and maintains database content and environment profiles. Using attributes of the content and environment stored in the profiles, the environment selection system 106 determines a compatibility score for selecting one of the environments 110 to present the content item.

### 3. ENVIRONMENT SELECTION SYSTEM

FIG. 1B is a block diagram illustrating an example environment selection system 106 in accordance with one or more embodiments. The environment selection system 106 includes hardware and software that perform processes and functions described herein. In one or more embodiments, the environment selection system 106 may include more or fewer components than the components illustrated in FIG. 1B. The components illustrated in FIG. 1B may be local to or remote from each other. The components illustrated in FIG. 1B may be implemented in software and/or hardware. Components may be distributed over multiple applications and/or machines. Multiple components may be combined into one application and/or machine. Operations described with respect to one component may instead be performed by another component.

One or more embodiments of the environment selection system 106 include a data repository 120 and a computing device 122. The data repository 120 includes any type of storage unit and/or device (e.g., a file system, database, collection of tables, or any other storage mechanism) for storing data. Furthermore, a data repository 120 may include multiple different storage units and/or devices. The multiple different storage units and/or devices may or may not be of the same type or located at the same physical site. Furthermore, the data repository 120 may be implemented or executed on the same computing system as environment selection system 106. Additionally, or alternatively, the data repository 120 may be implemented or executed on a computing system separate from environment selection system 106. The data repository 120 may be communicatively coupled, wired and/or wirelessly, to the environment selection system 106 via a direct connection or via a network. One or more embodiments of the data repository 120 store training database 140, machine learning algorithms 142, an environment scoring model 144, a content database 146, an environment profile database 148, a content profile database 150, an environment feature vector database 152, a content feature vector database 154, and a compatibility score database 156.

The training database 140 is one or more data structures storing sets of training data for training machine learning models. The training data sets include attributes or feature vectors representing contexts of content items. The training data sets also include environment attributes or feature vectors representing contexts of environments 110. The training data sets further include compatibility scores between respective content items and environments. A compatibility score is a metric quantifying the compatibility of a particular item of content with a particular environment 110. The compatibility scores are assigned by subject matter experts based on data collected from past placements of content in environments. The compatibility scores can also be calculated by the environment selection system 106 based on the historical metrics of past content placements. The metrics can be performance parameters of advertising campaigns that represent advertisement impressions or conversions generated by an item of content after placement in a particular environment.

The machine learning algorithms 142 are one or more algorithms that can be iterated to train machine learning models to map a set of input variables to an output variable. In particular, a machine learning algorithm 142 is configured to generate a target model such that the target model best fits the datasets of training data to the labels of the training data. Additionally, or alternatively, a machine learning algorithm 142 generates a target model such that when the target model is applied to the sets of the training data, a maximum number of results determined by the target model matches the labels of the training data. Different target models may be generated based on different machine learning algorithms and/or different sets of training data. The algorithms supervise components and/or unsupervised components. Algorithms, such as linear regression, logistic regression, linear discriminant analysis, classification and regression trees, naïve Bayes, k-nearest neighbors, learning vector quantization, support vector machine, bagging and random forest, boosting, backpropagation, and/or clustering may be used.

The environment scoring model 144 is a machine learning model trained to compute compatibility scores between content items and candidate environments. The environment scoring model 144 is trained by applying the training sets to a machine learning algorithm. The algorithm iteratively learns the relationship between the input feature vectors and the compatibility scores. Various types of algorithms, such as linear regression, logistic regression, linear discriminant analysis, classification and regression trees, naïve Bayes, k-nearest neighbors, learning vector quantization, support vector machine, bagging and random forest, boosting, backpropagation, and/or clustering may be used.

The content database 146 includes one or more data structures storing items of content that may be displayed in the metaverse 108. Content items include digital material, such as text, images, graphics, videos, animations, and/or audio. The content items may be, for example, promotional content of brands, manufacturers, retailers, suppliers, and the like.

The environment profile database 148 is one or more data structures associating the environments 110 with corresponding attributes. The environment attributes include characteristics, properties, metrics, and other information describing contexts of the environments 110. In one or more embodiments, the metaverse system 102 maintains sets of environment attributes for environments 110 and transmits the environment attributes to the environment selection system 106. For example, programmers of the metaverse system 102 can generate and maintain a library of environment attributes for the environments 112. Additionally, or alternatively, the metaverse system 102 can generate the environment attributes by scraping keywords from metadata, code, libraries, objects, and content of the environments using natural language processing (NLP) image recognition techniques and semantic analysis. For example, the environment selection system 106 can scrape metadata from library names and code header fields using a set of predefined keywords.

The content profile database 150 is one or more data structures associating content items stored in the content database 146 with corresponding attributes. The content attributes can include keywords indicating the content item's type, subject matter, theme, and demographics. In one or more embodiments, the content placement system 106 obtains the content attributes from content providers. Additionally, or alternatively, the metaverse system 102 can generate the content attributes by scraping keywords from metadata, software code, and content of the content items using natural language processing (NLP), image recognition, and semantic processing techniques. For example, the environment selection system 106 can identify, classify, and translate elements included in content images and audio.

Feature vectors include one-dimensional arrays containing attributes. The elements of a feature vector correspond to a respective attribute. The feature vectors are applied as inputs to the machine learning algorithms 142 for training the machine learning models to represent a point in a multidimensional feature space, where the individual dimensions represent a different attribute. The arrangement of points in the feature space captures the relationships between different attributes. The environment feature vector database 152 is one or more data structure storing environment feature vectors generated for the environments 110 using the environment profiles in environment profile database 148. The content feature vector database 154 includes feature vectors generated for content using the content profiles in the content profile database 146.

The compatibility score database 156 includes one or more data structures associating compatibility scores with respective pairs of environment attributes and content attributes. The compatibility scores are metrics quantifying the compatibility of a particular item of content with a corresponding environment 110. The environment scoring model 144 populates the the compatibility score database 156 by calculating the scores based on content feature vectors of environments 110.

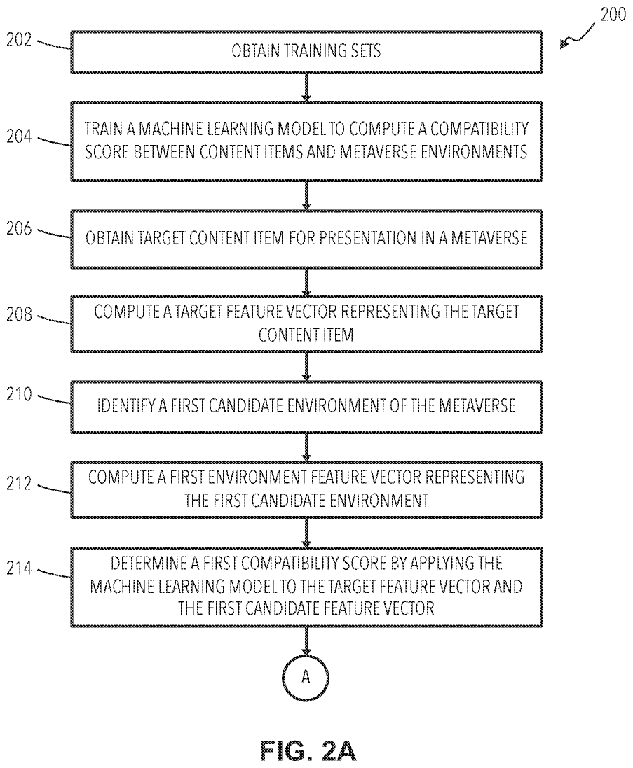

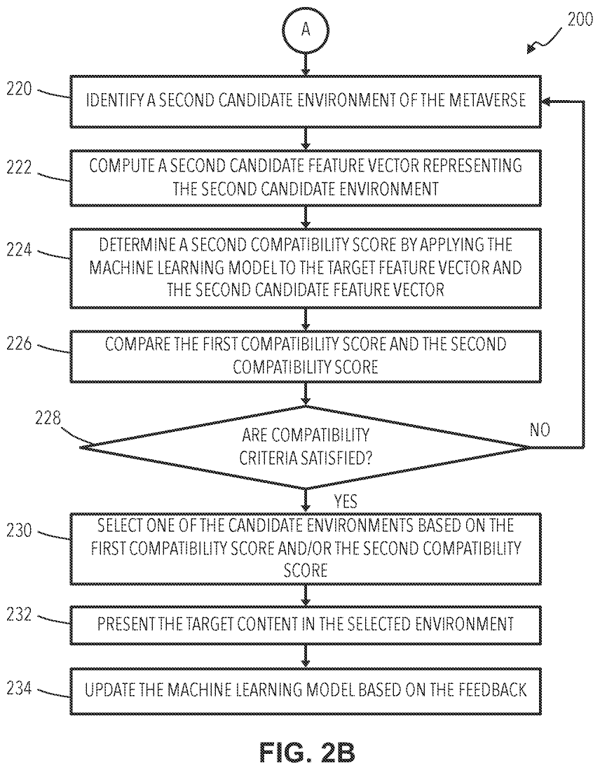

In one or more embodiments, computing device 122 includes hardware and/or software configured to perform operations described herein. Example operations are described below with reference to FIGS. 2A and 2B. The computing device 122 executes computer-readable program instructions, such as an operating system and application programs, that are stored in memory devices and/or the storage system. Moreover, the computing device 122 executes program instructions of a machine learning (ML) training module 170, an attribute generation module 172, a feature vector generation module 174, an environment scoring module 176, and an environment selection module 178.

The machine learning training module 170 trains the environment scoring model 144 using environment attributes, content attributes, and compatibility scores included in the training database 150 as well as weights or other labels applied to the various data. Once trained, the environment scoring model 144 can calculate compatibility scores to select environments 110 compatible with contexts of particular content items and store the compatibility scores in the compatibility score database 156.

The attribute generation module 172 generates attributes from metadata, software code, and content of the environments and content items. The attribute generation module 172 can extract environment attributes and content attributes by parsing metadata, code, and object libraries of the environments and content to identify predefined keywords. Additionally, the attribute generation module 172 can scrape audio, video, images, and text from within the environments and content using natural language processing (NLP), image recognition techniques, and semantic analysis techniques. For example, the attribute generation module 172 can identify objects on the environment, such as vehicles, buildings, mountains, lakes, flora, and fauna. The attribute generator module 172 can also analyze text captured from rendered images, audio, and content to identify keywords. Furthermore, attribute generator module 172 can generate attributes by parsing data libraries associated with the environments and content. For example, the system can extract terms from libraries of objects and textures. Moreover, attribute generator module 172 can perform classification processing (e.g., using a trained machine learning model) to infer additional keywords.

The feature vector generation module 174 generates feature vectors for application to the distance algorithms and machine learning algorithms. For example, the feature vector generation module 174 can generate environment feature vectors by extracting attributes from environment profiles and storing the generated environment feature vectors in the environment feature vector database 152. Additionally, the feature vector generation module 174 can generate content feature vectors for content items by extracting attributes from the content profiles and storing the content feature vectors in the content feature vector database 154.

The environment scoring module 176 applies the trained environment scoring model 144 to calculate compatibility scores based on attributes of content items and environments 110 such as described below regarding FIGS. 2A and 2B. The compatibility scores generated by the environment scoring module 176 quantify the extent of alignment and relevance between the attributes of the content and the attributes of the environments 110. One or more embodiments scale and/or normalize the determined compatibility scores to generate scores within a predetermined range, such as values from 1 to 10.

The environment selector module 178 selects content for presentation in compatible environments 110 of the metaverse 108 based on a compatibility score determined by the environment scoring model 176. The environment selector module 178 may select a content item in an environment 100 in response to a request from the metaverse system 102 to fill an available content location in an environment 110. For example, in response to determining that content currently displayed in the environment 110A is scheduled to expire, the metaverse system 102 can generate a request for new content from the environment selection system 106. Additionally, or alternatively, the environment selection system 106 can place content in an environment 110 in response to receiving the content item from a content provider. For example, a content provider can provide a content item to the environment selection system 106 from a pool, queue, or schedule of content.

### 4. SELECTING SUITABLE ENVIRONMENTS FOR PLACING CONTENT

One or more embodiments select an environment of a metaverse for placement of a content item based at least in part on a compatibility score indicating the compatibility between the environment and the content item. The system may evaluate any number of candidate environments to compute respective compatibility scores in relation to a content item that is to be placed in a metaverse. The system may select a candidate environment corresponding to the highest compatibility score, of the set of compatibility scores, for placement of the content item. Alternatively, the system may select the chronologically first identified candidate environment with a corresponding compatibility score that meets a threshold value.

Compatibility scores may be computed by a machine learning model that has been trained on data indicating the compatibility scores between content item-environment pairs. Compatibility scores may be computed based on a comparison of attributes associated with content items and environments. In an example, relationships between the various characteristics of a content item and the various characteristics of an environment are represented using numerical values. A compatibility score is then computed as a function as of the numerical values.

FIGS. 2A and 2B illustrate an example set of operations for a process (200) of selecting a metaverse environment for placement of content based on subject matter of the content. One or more operations illustrated in FIGS. 2A and 2B may be modified, rearranged, or omitted. Accordingly, the particular sequence of operations illustrated in FIGS. 2A and 2B should not be construed as limiting the scope of one or more embodiments.

A system obtains training sets for training a machine learning model to calculate compatibility scores for content items and metaverse environments (Operation 202). The training sets include pairs of feature vectors representing attributes of metaverse environments and attributes of content items. As described above, the system can obtain the attributes from a data repository such as a training database. Additionally, the training data sets can also include compatibility scores indicating compatibility of environments for past placements of content. As described above, an individual, such as a subject matter expert, can assign the compatibility scores. Additionally, or alternatively, a computing system can calculate the compatibility scores based on historical performance metrics of past content placements.

Using the training sets, the system trains the machine learning model to compute the compatibility scores between content items and respective candidate environments (Operation 204). One or more embodiments train the machine learning model by applying the training sets to a supervised machine learning algorithm. The algorithm can be, for example, a linear regression algorithm or a random forest algorithm. Using the feature vectors as inputs and the corresponding compatibility scores as labels, the algorithm iteratively learns the relationship between the inputs and labels. A subset of the training set can be used to verify that the trained machine learning model is sufficiently accurate by comparing compatibility scores output from the model to the known compatibility scores of the training sets. Evaluation metrics, such as F1-score, mean squared error, and R-squared can be used to assess the performance of the trained machine learning model on the verification data.

The system obtains a target content item for presentation in a metaverse (Operation 206). The target content item can be, for example, an image, an audio file, a video clip, a short film, an educational video, or a promotional display to be placed in a compatible environment of the metaverse. The system can retrieve the target content item from a content database in response to a request from a metaverse to fill an available content location. The system can also receive the target content item from a content provider, such as an advertiser or retailer, for placement in the metaverse.

The system computes a target feature vector representing the target content item (Operation 208). Generating the feature vector can include obtaining attributes of the content item. As detailed previously, the content attributes can include keywords that describe type, subject matter, theme, target demographics, and other characteristics of the target content item. The system can retrieve the content attributes corresponding to the content item from a content profile database maintained by the system. Also, the system can receive the content attributes from a content provider along with the content item. Furthermore, the system can analyze the content item to generate attributes using, for example, natural language processing (NLP), image recognition, and semantic analysis. Using the content attributes, the system determines a target feature vector for the target content item.

The system identifies a first candidate environment of the metaverse (Operation 210). The system can select the first candidate environment from a list of environments included in the metaverse. In large metaverses, for example, the system can pre-filter the list of environments based on metadata associated with the target content item. For example, the system can filter the list based on “type” information to lower the quantity of candidates. The system can filter out candidate environments that are already saturated with content items and/or previously been selected for placement of content items. This filtering operation may allow for balancing content items across environments in the metaverse.

The system computes a first environment feature vector representing the first candidate environment (Operation 212). The system generates the first environment feature vector based on attributes of the first candidate environment in a same or similar manner to that previously described above regarding the target feature vector. The system can retrieve the first environment attributes corresponding to the first candidate environment from an environment profile database maintained by the system. Also, the system can analyze the first candidate environment to generate attributes using, for example, natural language processing (NLP), image recognition, and semantic analysis. Using the first environment's attributes, the system determines the first environment feature. Computing first environment feature vector includes representing the set of attributes as a single numerical vector.

The system determines a first compatibility score by applying the trained machine learning model to the target feature vector and the first candidate environment feature vector (Operation 214). The system uses the feature vector of the target content item and the feature vector of the first candidate environment as inputs to the machine learning model score. As described above, the system obtains the compatibility score as an output of the model. The first compatibility score can be stored in a compatibility score database for reference and comparison.

Referring to FIG. 2B, the system identifies a second candidate environment of the metaverse (Operation 220). As described above, the system can select the second candidate environment from a list of environments included in the metaverse and pre-filter the list of environments.

The system computes a second environment feature vector representing the second candidate environment (Operation 222). The system generates the second environment feature vector based on attributes of the second candidate environment in a same or similar manner to that previously described above regarding the first environment feature vector. Computing the second environment feature vector includes representing the set of attributes as a single numerical vector.

The system determines a second compatibility score by applying the machine learning model to target feature vector and the second candidate feature vector (Operation 224). The system uses the feature vector of the target content item and the feature vector of the second candidate as inputs to the machine learning model. As described above, the system obtains a second compatibility score as an output of the model. The system stores the second compatibility score in association with the second environment for analysis and reference.

Some embodiments perform the above operations (220-224) multiple iterations to generate additional compatibility scores for additional candidate environments. The system can perform the operations for some or all of the environments included in a particular metaverse.

One or more embodiments of the system compare a set of compatibility scores, including the first compatibility score and the second compatibility score (Operation 226). Comparing the scores can include determining if the first compatibility score is greater than the second compatibility score. For example, the compatibility scores can be a normalized value in a range from 0 to 10, where a greater value indicates greater compatibility with the target content item. As such, if the compatibility score of the first candidate environment is 9, and the compatibility score of the second candidate environment is 2, the system can identify the first candidate environment as being more compatible with the target content item than the second candidate environment.

One or more embodiments determine if the compatibility scores satisfy a compatibility criteria (Operation 228). The system can include logic that calculates if the first and/or second compatibility scores satisfy one or more of the criteria rules. The criteria can include if a compatibility score is the highest value in a set of compatibility scores. Additionally, or alternatively, the criteria can also include if a compatibility score is greater than a predetermined threshold value. For example, a rule may require candidate environments to have a minimum compatibility score of 3 out of 10. If the compatibility score of all the candidate environments in the set of candidate environments fails to meet the criterion (Operation 228 is “No”), then the process (200) iteratively repeats by identifying another candidate environment as described above.

If one of the compatibility scores meet criteria (Operation 228 is “Yes”), then the system selects the corresponding candidate environment for placement in the metaverse (Operation 230). Some embodiments select a candidate environment corresponding to the highest compatibility score, of the set of compatibility scores, that satisfies the criteria. Some other, the system may select the chronologically first identified candidate environment with a corresponding compatibility score that satisfies the criteria. The system then presents a content item in the selected candidate environment (Operation 232). Placing the content includes transmitting the content item to a metaverse system with information indicating the particular environment. The metaverse can then identify a location for placing the content and render the content at that location.

The system updates the machine learning model based on feedback (Operation 234). Determining feedback can include obtaining assessments of the output by an operator of a content placement system and/or content providers that evaluate placement of content in environments as described above. Determining feedback can also include comparing the determined compatibility scores to known outcomes in a set of training data. The difference between the current compatibility scores and the known outcome can be quantified using a loss function. For example, the loss function can determine a metric quantifying a deviation from the known outcomes and revise attributes associated with a deviation. Additionally, determining feedback can also include determining an evaluation metrics, such as accuracy, precision, recall, F1-score, or area under the receiver operating characteristic curve (ROC-AUC).

Using the feedback, the system updates the machine learning. Updating the machine learning model can include re-engineering the content of the feature vectors. Additionally, the updating can include tuning parameters of the model using various techniques, such as grid search, random search, or Bayesian optimization. For example, a grid search can use predefined set of hyperparameter values for a machine learning model to identify an optimal combination that yields the best performance. Using the updated training data, feature vectors, and parameters, the system can iteratively retrain the machine learning model.

### 5. EXAMPLE EMBODIMENT OF ENVIRONMENT SELECTION

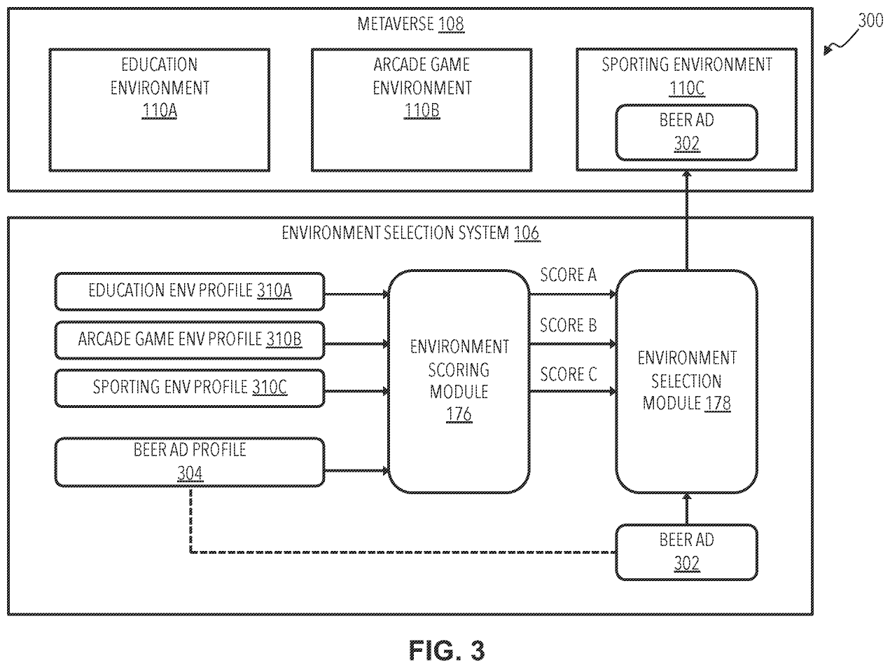

FIG. 3 shows a functional block diagram illustrating an example process (300) of selecting and placing content in a compatible environment of a metaverse in accordance with one or more embodiments. The example is described for purposes of clarity. Components and/or operations described below should be understood as one specific example that may not be applicable to certain embodiments. Accordingly, components and/or operations described below should not be construed as limiting the scope of any of the claims.

The process (300) involves an environment selection system 106 and a metaverse 108 that can be the same as those previously described above. In the present example, the metaverse 108 includes three environments: an education environment 110A, an arcade game environment 110B, and a sporting environment 110C. The environments 110A, 110B, and 110C include locations configured to display content items. For example, the environments 110A, 110B, and 110C can each include an object, such as a virtual billboard, including a location configured to display promotional content sourced from content providers, such as advertisers or retailers. The environment selection system 106 includes an environment scoring module 176 and an environment scoring model 178 that are both the same as previously described.

The environment selection system 106 obtains a target content item 302 for placement in the metaverse 108. In the present example, the target content 302 is a beer advertisement. In some embodiments, the metaverse 108 outputs a request for content to the environment selection system 106. The request triggers the environment selection system 106 to obtain the beer advertisement and determines one of the environments 110A, 110B, or 110C for placement of the advertisement based on the respective compatibility scores of the environments 110A, 110B, or 110C. In some other embodiments, the environment selection system 106 places the beer advertisement in response to receiving the advertisement from a content provider.

The beer advertisement content 302 is associated with a content profile 304, including set of content attributes describing the context of the advertisement. As described above, the attributes include the following: type, themes, settings, goals, demographics, and other characteristics of the advertisement. The content provider can transmit the beer advertisement profile 304 to the environment selection system 106. Additionally, or alternatively, the environment selection system 106 can extract content attributes from the beer advertisement content 302. For example, the context of the beer advertisement content 302 can be a video depicting men aged 21 or older opening cans of beer while sitting on the tailgate of a truck in front of a football stadium. Using screen capture, image recognition, and NLP techniques, the content placement system 106 can determine keywords by identifying text, objects, and physical characteristics corresponding to the beer advertisement content 302, such as Acme Beer Corp, alcohol, men, truck, the truck's brand and model, football, stadium, outdoors, etc.

The environment selection system 106 identifies one or more of environments 110A, 110B, and 110C as candidate environments for presenting the beer advertisement content 302. The candidate environments 110A, 110B, and 110C can be associated with a respective environment profile 310A, 310B, and 310C including corresponding environment attributes. Based on the attributes included in the environment profiles 310A, 310B, and 310C, the environment scoring module 176 determines respective compatibility scores A, B, and C with the beer advertisement content 302. As detailed above, the environment scoring module 176 applies a machine learning model trained to generate compatibility scores by generating feature vectors representing attributes the beer advertisement profile 304 and feature vectors representing attributes of the identified environments profiles 310A, 310B, and 310C.

Based on the values of the compatibility scores A, B, and C, the environment selection module 178 determines if placement criteria are satisfied. For example, the environment selection module 178 can rank the candidate environments 110A, 110B, and 110C based on the compatibility scores A, B, and C, and select the highest ranking score. Additionally, the environment selection module 178 can determine if any of the compatibility scores A, B, and C exceed a specified threshold and filter out environments 110A, 110B, and 110C that do not exceed the threshold.

In the present example, the compatibly score A of the beer advertisement content 302 with the education environment 110A would be low based on the subject matter target and demographics of educational contexts typically excluding alcohol or sports. As such, the environment selection module 178 would determine the compatibility score A of the education environment 110A with the beer advertisement content 302 is a low value, such as 1 out of 10. Likewise, the compatibly score B of the beer advertisement content 302 with the arcade game environment would also be low based on the subject matter and target demographics of arcade game contexts also typically excluding alcohol or sports. As such, the environment selection module 178 would determine the compatibility score B of the education environment 110A with the beer advertisement content 302 is a low value, such as 5 out of 10. In comparison, the compatibly score C of the beer advertisement content 302 with the sporting environment 110C would be high based on the subject matter target demographics of sporting events. As such, the environment selection module 178 would determine the compatibility score C of the education environment 110A with the beer advertisement content 302 is a high value, such as 9 out of 10. Accordingly, as illustrated in FIG. 3, the environment selection system 106 would place the beer advertisement in the sporting environment 110C.

As described above, the process 300 identifies a set of candidate environments and selects one candidate environment from the set of based on the selected candidate environment having the highest compatibility score. For example, the process 300 selects candidate environment 110C because candidate environment 110C has the highest compatibility score among the candidate environments 110A, 110B, and 110C. Alternatively, the process 300 can select a chronologically first identified candidate environment with a corresponding compatibility score that meets a threshold value. For example, the threshold value can have a value of 5. The process 300 may first identify candidate environment 110A and determine that its compatibility score (e.g., 1) does not satisfy the threshold (e.g., 5). The process 300 can then identify candidate environment 110B and determine that its compatibility score (e.g., 5) does satisfy the threshold. Accordingly, the process 300 would place the beer advertisement content 302 in candidate environment 110B without identifying and evaluating candidate environment 110C even though candidate environment 110C would have a greater compatibility score (e.g., 9) than candidate environment 110B.

### 6. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

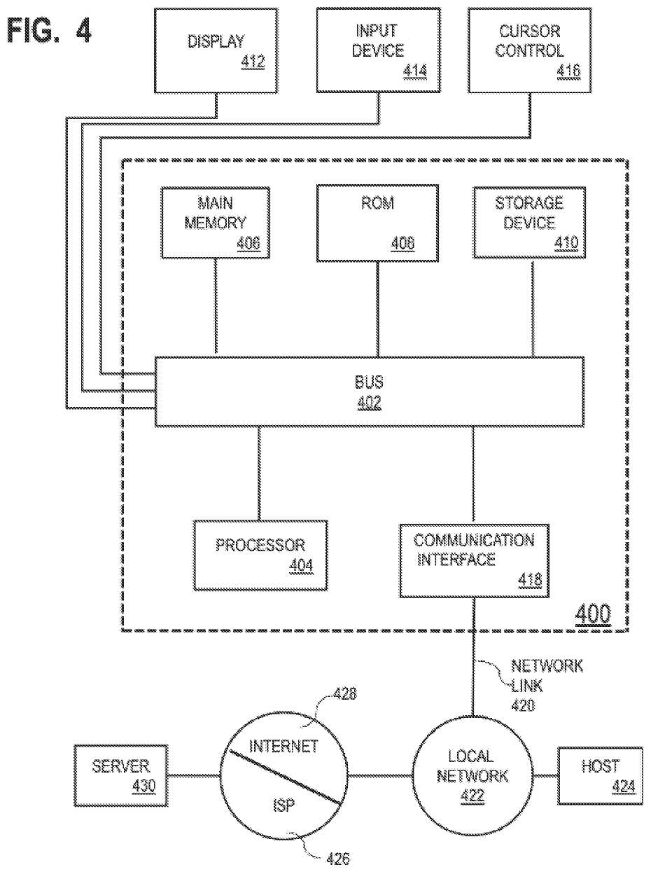

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 7. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form where such claims issue, including any subsequent correction.

What is claimed is:

1. One or more non-transitory computer readable media comprising instructions that, when executed by one or more hardware processors, causes performance of operations comprising:
obtaining a plurality of training sets for training a machine learning model, individual training sets of the plurality of training sets comprising:
attributes of a particular content item;
attributes of a particular metaverse environment;
a particular compatibility score representing a particular level of compatibility between the particular content item and the particular metaverse environment;
training the machine learning model based on the plurality of training sets;
identifying a first content item;
identifying a first candidate metaverse environment for the first content item;
applying the machine learning model to attributes of the first content item and attributes of the first candidate metaverse environment to compute a first compatibility score representing a first level of compatibility between the first content item and the first candidate metaverse environment; and
based at least on the first compatibility score, selecting the first candidate metaverse environment as a target metaverse environment for placement of the first content item.

2. The one or more non-transitory computer readable media of claim 1, wherein the operations further comprise:
identifying a second candidate metaverse environment;
applying the machine learning model to the attributes of the first content item and attributes of the second candidate metaverse environment to compute a second compatibility score representing a second level of compatibility between the first content item and the second candidate metaverse environment; and
determining that the first compatibility score is higher than the second compatibility score;
wherein the first candidate metaverse environment is selected as the target metaverse environment for placement of the first content item based at least in part on determining that the first compatibility score is higher than the second compatibility score.

3. The one or more non-transitory computer readable media of claim 1, wherein applying the machine learning model comprises:
computing an environment feature vector based on keywords associated with the first candidate metaverse environment.

4. The one or more non-transitory computer readable media of claim 3, wherein the operations further comprise:
determining the keywords associated with the first candidate metaverse environment by scraping information from the first candidate metaverse environment.

5. The one or more non-transitory computer readable media of claim 4, wherein the operations further comprise identifying the keywords associated with the first candidate metaverse environment based on or more of:
metadata associated with the first candidate metaverse environment;
code associated with the first candidate metaverse environment;
subject matter displayed in the first candidate metaverse environment; and
objects included in the first candidate metaverse environment.

6. The one or more non-transitory computer readable media of claim 1, wherein applying the machine learning model comprises:
computing a content feature vector based on keywords associated with the first content item.

7. The one or more non-transitory computer readable media of claim 6, wherein the operations further comprise:
determining the keywords associated with the first content item by scraping information from the first content item.

8. A method comprising:
obtaining a plurality of training sets for training a machine learning model, individual training sets of the plurality of training sets comprising:
attributes of a particular content item;
attributes of a particular metaverse environment;
a particular compatibility score representing a particular level of compatibility between the particular content item and the particular metaverse environment;
training the machine learning model based on the plurality of training sets;
identifying a first content item;
identifying a first candidate metaverse environment for the first content item;
applying the machine learning model to attributes of the first content item and attributes of the first candidate metaverse environment to compute a first compatibility score representing a first level of compatibility between the first content item and the first candidate metaverse environment; and
based at least on the first compatibility score, selecting the first candidate metaverse environment as a target metaverse environment for placement of the first content item.

9. The method of claim 8, further comprising:
identifying a second candidate metaverse environment;
applying the machine learning model to the attributes of the first content item and attributes of the second candidate metaverse environment to compute a second compatibility score representing a second level of compatibility between the first content item and the second candidate metaverse environment; and
determining that the first compatibility score is higher than the second compatibility score;
wherein the first candidate metaverse environment is selected as the target metaverse environment for placement of the first content item based at least in part on determining that the first compatibility score is higher than the second compatibility score.

10. The method of claim 8, wherein applying the machine learning model comprises:
computing an environment feature vector based on keywords associated with the first candidate metaverse environment.

11. The method of claim 10, further comprising:
determining the keywords associated with the first candidate metaverse environment by scraping information from the first candidate metaverse environment.

12. The method of claim 11, further comprising identifying the keywords associated with the first candidate metaverse environment based on or more of:
metadata associated with the first candidate metaverse environment;
code associated with the first candidate metaverse environment;
subject matter displayed in the first candidate metaverse environment; and
objects included in the first candidate metaverse environment.

13. The method of claim 8, wherein applying the machine learning model comprises:
computing a content feature vector based on keywords associated with the first content item.

14. The method of claim 13, further comprising:
determining the keywords associated with the first content item by scraping information from the first content item.

15. A system comprising:
at least one device including a hardware processor;
the system being configured to perform operations comprising:
obtaining a plurality of training sets for training a machine learning model, individual training sets of the plurality of training sets comprising:
attributes of a particular content item;
attributes of a particular metaverse environment;
a particular compatibility score representing a particular level of compatibility between the particular content item and the particular metaverse environment;
training the machine learning model based on the plurality of training sets;
identifying a first content item;
identifying a first candidate metaverse environment for the first content item;
applying the machine learning model to attributes of the first content item and attributes of the first candidate metaverse environment to compute a first compatibility score representing a first level of compatibility between the first content item and the first candidate metaverse environment; and
based at least on the first compatibility score, selecting the first candidate metaverse environment as a target metaverse environment for placement of the first content item.

16. The system of claim 15, wherein the operations further comprise:
identifying a second candidate metaverse environment;
applying the machine learning model to the attributes of the first content item and attributes of the second candidate metaverse environment to compute a second compatibility score representing a second level of compatibility between the first content item and the second candidate metaverse environment; and
determining that the first compatibility score is higher than the second compatibility score;
wherein the first candidate metaverse environment is selected as the target metaverse environment for placement of the first content item based at least in part on determining that the first compatibility score is higher than the second compatibility score.

17. The system of claim 15, wherein applying the machine learning model comprises:
computing an environment feature vector based on keywords associated with the first candidate metaverse environment.

18. The system of claim 17, wherein the operations further comprise:
determining the keywords associated with the first candidate metaverse environment by scraping information from the first candidate metaverse environment.

19. The system of claim 18, wherein the operations further comprise identifying the keywords associated with the first candidate metaverse environment based on or more of:
metadata associated with the first candidate metaverse environment;
code associated with the first candidate metaverse environment;
subject matter displayed in the first candidate metaverse environment; and
objects included in the first candidate metaverse environment.

20. The system of claim 15, wherein applying the machine learning model comprises:
computing a content feature vector based on keywords associated with the first content item; and
determining the keywords associated with the first content item by scraping information from the first content item.
